(19) United States
(12) Patent Application Publication
(10) Pub. No.: US 2018/0255122 A1
(43) Pub. Date: Sep. 6, 2018

(54) LEARNING-BASED RESOURCE MANAGEMENT IN A DATA CENTER CLOUD ARCHITECTURE

(71) Applicant: Futurewei Technologies, Inc., Plano, TX (US)

(72) Inventors: Luhui Hu, Bellevue, WA (US); Hui Zang, Santa Clara, CA (US); Ziang Hu, Santa Clara, CA (US)

(21) Appl. No.: 15/448,451

(22) Filed: Mar. 2, 2017

(51) Int. Cl. H04L 29/08; H04W 72/04; H04L 12/911

(52) U.S. Cl. CPC H04L 67/10; H04L 47/72; H04W 72/04

(57) ABSTRACT

A mobile device, computer readable medium, and method are provided for allocating resources within a cloud. The method includes the steps of receiving metrics data associated with one or more tasks, training one or more models based on the metrics data to predict scores for tasks executed with a particular number of resource units, receiving a request that specifies a first task for processing a dataset, determining an optimal number of resource units to allocate to the first task based on predicted scores output by a first model, and allocating the optimal number of resource units to a resource agent in the cloud to manage the execution of the first task. The metrics data, which is collected by a plurality of cognitive agents, is received by a cognitive engine service in communication with the plurality of cognitive agents deployed in the cloud.

### FIELD OF THE INVENTION

The present disclosure relates to a cloud architecture for management of data center resources, and more particularly to learning-based resource management solutions implemented within the cloud architecture.

### BACKGROUND

The “cloud” is an abstraction that relates to resource management over a network and, more specifically, to a data center architecture that provides a platform for delivering services via a network. For example, the cloud may refer to various services delivered over the Internet such as network-based storage services or compute services. Typical cloud architecture deployments include a layered hierarchy that includes a physical layer of network hardware, and one or more software layers that enable users to access the network hardware. For example, one common type of cloud architecture deployment includes a physical layer of network resources (e.g., servers, storage device arrays, network switches, etc.) accompanied by a multi-layered hierarchical software framework that includes a first layer that implements Infrastructure as a Service (IaaS), a second layer that implements Platform as a Service (PaaS), and a third layer that implements Software as a Service (SaaS). In general, although there may be exceptions, resources in the third layer are dependent on resources in the second layer, resources in the second layer are dependent on resources in the first layer, and resources in the first layer are dependent on resources in the physical layer.

In conventional cloud architectures, the resources in the physical layer may be allocated to services implemented in the first layer (i.e., IaaS services). For example, a resource manager for the first layer may be configured to allocate resources in the physical layer to different IaaS services running in the first layer. Examples of IaaS services include the Amazon® Elastic Compute Cloud (EC2) platform, which enables a client to reserve one or more nodes in the physical layer of the cloud to perform some computations or run an application, and the Amazon® Simple Storage Service (S3) storage platform, which provides cloud-based storage in one or more data centers. Each instance of an IaaS service may also include a resource manager that requests resources to implement the service from the resource manager of the first layer and manage the allocated resources within the service.

In turn, the resources in the first layer (i.e., IaaS services) may be allocated to services implemented in the second layer (i.e., PaaS services). For example, a resource manager for the second layer may be configured to allocate resources in the first layer to different PaaS services running in the second layer. Examples of PaaS services include the Microsoft® Azure App Service platform, which enables a client to build applications that run on a Microsoft cloud infrastructure, and the Google® Heroku platform, which enables a client to build applications that run on Amazon® IaaS services. PaaS services typically provide containers that manage infrastructure resources such that applications running in the cloud are easily scalable without the developer having to manage those resources. Again, multiple PaaS services may be run simultaneously in the PaaS layer, each PaaS service including a separate and distinct resource manager that is dependent on the resource manager of the PaaS layer for requesting resources to run the PaaS service.

The resources in the second layer (i.e., PaaS services) may be allocated to services implemented in the third layer (i.e., SaaS services). For example, a resource manager for the third layer may be configured to allocate resources from the second layer to different SaaS services running in the third layer. Examples of SaaS services include Salesforce (i.e., customer relations software), Microsoft Office 365, Google Apps, Dropbox, and the like. Each SaaS service in the third layer may request resources from a PaaS service in the second layer in order to run the application. In turn, the PaaS service may request resources from an IaaS service in the first layer to run the platform on which the application depends, and the IaaS service may request a specific subset of resources in the physical layer in one or more data centers of the cloud to be allocated as infrastructure to run the platform.

As the previous description makes clear, each hierarchical layer of the cloud architecture depends on the hierarchical layer below it for allocated resources. Resources in the cloud are partitioned vertically on a first-come, first-served basis where each resource manager only allocates the resources allocated to that resource manager to dependent services corresponding to that resource manager. In addition, the resource pools of the cloud may be partitioned horizontally into different clusters, such as by partitioning the total resources in the physical layer of the cloud into individual clusters partitioned by data center or availability zone. As such, each service implemented in a particular cluster only has access to the resources allocated to that cluster, which may be a subset of the resources included in the cloud.

The resulting allocation of resources in such architectures is typically inefficient. For example, a particular application (i.e., SaaS) in one cluster may have a high resource utilization rate as many users are using the particular application, which is slowed down because the application can only run on the resources allocated to that cluster, but another application in another cluster may have a low resource utilization rate because only a few users are using the particular application. The resource manager in the first level that allocates resources in the physical layer to the two different clusters may not have visibility into the resource utilization rates of different applications running on each cluster and, therefore, the resources of the physical layer may be utilized inefficiently.

In addition, each service may be designed for a specific platform or cloud based infrastructure. For example, a resource manager for one SaaS service may be designed to utilize the Google® Heroku platform, while a resource manager for another SaaS service may be designed for the Microsoft® Azure App Service platform. Migrating the service from one platform to another platform may take a large amount of effort as programmers develop a compatible resource manager to enable the service to be run on the different platform. Furthermore, some cloud architectures may have different layers, such as a CaaS/SaaS cloud architecture or even a serverless architecture (e.g., Amazon® AWS Lambda).

In general, it is difficult to migrate services built for a particular cloud architecture to another cloud architecture because a service designed for one architecture may depend on receiving allocated resources from other services, which may not be available in other architectures. Furthermore, resource management is typically limited to requesting resources to be allocated to the service from a “parent” resource manager that has access to a particular resource pool. This type of resource management can result in inefficient allocation of the resources available in the cloud.

### SUMMARY

A mobile device, computer readable medium, and method are provided for allocating resources within a cloud. The method includes the steps of receiving metrics data associated with one or more tasks, training one or more models based on the metrics data to predict scores for tasks executed with a particular number of resource units, receiving a request that specifies a first task for processing a dataset, determining an optimal number of resource units to allocate to the first task based on predicted scores output by a first model, and allocating the optimal number of resource units to a resource agent in the cloud to manage the execution of the first task. The metrics data, which is collected by a plurality of cognitive agents, is received by a cognitive engine service in communication with the plurality of cognitive agents deployed in the cloud.

In a first embodiment, each model in the one or more models implements a machine learning algorithm.

In a second embodiment (which may or may not be combined with the first embodiment), the machine learning algorithm is a regression algorithm.

In a third embodiment (which may or may not be combined with the first and/or second embodiments), the profile comprises a customer identifier and a task identifier. The profile is utilized to select the first model from the one or more models.

In a fourth embodiment (which may or may not be combined with the first, second, and/or third embodiments), the metrics data includes at least one of a processor utilization metric, a memory utilization metric, a network bandwidth utilization metric, and an amount of time elapsed to execute the task. The cognitive engine service is configured to calculate a score corresponding to each task in the one or more tasks based on the metrics data.

In a fifth embodiment (which may or may not be combined with the first, second, third, and/or fourth embodiments), the method includes the additional steps of correlating scores calculated for the one or more tasks to corresponding profiles.

In a sixth embodiment (which may or may not be combined with the first, second, third, fourth, and/or fifth embodiments), the cloud comprises a plurality of nodes in one or more data centers. Each node in the plurality of nodes is in communication with at least one other node in the plurality of nodes through one or more networks.

In a seventh embodiment (which may or may not be combined with the first, second, third, fourth, fifth, and/or sixth embodiments), each node in the plurality of nodes includes a cognitive agent stored in a memory and executed by one or more processors of the node.

To this end, in some optional embodiments, one or more of the foregoing features of the aforementioned apparatus, system, and/or method may afford a cognitive engine service in communication with a plurality of cognitive agents deployed in a cloud that, in turn, may enable the cognitive engine service to collect data for use in machine learning algorithms to assist with resource allocation. It should be noted that the aforementioned potential advantages are set forth for illustrative purposes only and should not be construed as limiting in any manner.

### BRIEF DESCRIPTION OF THE DRAWINGS

FIGS. 1A and 1B illustrate the infrastructure for implementing a cloud, in accordance with the prior art;

FIG. 2 is a conceptual illustration of a cloud architecture, in accordance with the prior art;

FIG. 3 is a conceptual illustration of a cloud architecture, in accordance with one embodiment;

FIG. 4 illustrates a cognitive engine service, in accordance with one embodiment;

FIG. 5 is a flowchart of a method for determining a number of resource units to allocate to a task, in accordance with one embodiment;

FIG. 6 is a flowchart of a method for training a model, in accordance with one embodiment;

FIG. 7A is a flowchart of a method for determining an optimal number of resource units to allocate to a task, in accordance with another embodiment;

FIG. 7B is a flowchart of a method for assigning an optimal number of resource units to allocate, in accordance with one embodiment; and

FIG. 8 illustrates an exemplary system in which the various architecture and/or functionality of the various previous embodiments may be implemented.

### DETAILED DESCRIPTION

Conventionally, resource allocation in a cloud architecture has been implemented based on a resource dependence scheme, where each resource manager in the cloud requests resources from a parent resource manager. In such cloud architectures, many hundreds or thousands of resource managers may be implemented as hundreds or thousands of services are deployed within the cloud. This large network of dependent resource managers are not designed to communicate and, therefore, the allocation of resources among this multi-layered network of resource managers is very likely to become inefficient.

One possible solution to the resource allocation problem is to transition from a distributed, multi-layered resource dependence scheme to a physically distributed, logically central resource allocation scheme. In this scheme, each resource manager deployed in the cloud is an agent that is dependent on a unified resource manager. The unified resource manager is tasked with allocating resource units among the plurality of resource agents, enabling the unified resource manager to efficiently distribute resource units among all of the services deployed within the cloud. However, as networks grow and the number of services increases, determining an efficient resource allocation plan becomes more and more difficult. Machine-learning may be utilized by the unified resource manager to assist in developing a resource allocation plan.

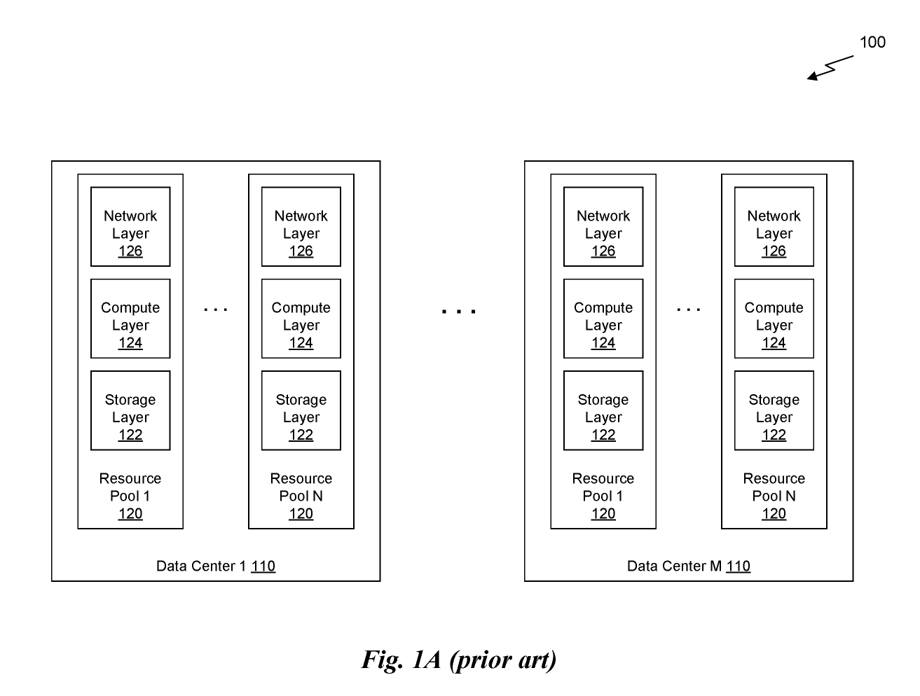

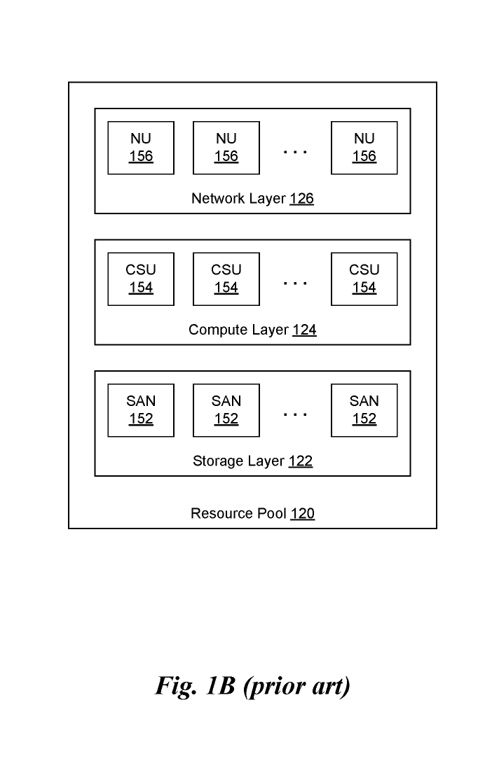

FIGS. 1A and 1B illustrate the infrastructure for implementing a cloud 100, in accordance with the prior art. The cloud 100, as used herein, refers to the set of hardware resources (compute, storage, and networking) located in one or more data centers (i.e., physical locations) and the software framework to implement a set of services across a network, such as the Internet. As shown in FIG. 1A, the cloud 100 includes a plurality of data centers 110, each data center 110 in the plurality of data centers 110 including one or more resource pools 120. A resource pool 120 includes a storage layer 122, a compute layer 124, and a network layer 126.

As shown in FIG. 1B, the storage layer 122 includes the physical resources to store instructions and/or data in the cloud 100. The storage layer 122 includes a plurality of storage area networks (SAN) 152, each SAN 152 provides access to one or more block level storage devices. In one embodiment, a SAN 152 includes one or more non-volatile storage devices accessible via the network. Examples of non-volatile storage devices include, but are not limited to, hard disk drives (HDD), solid state drives (SSD), flash memory such as an EEPROM or Compact Flash (CF) Card, and the like. In another embodiment, a SAN 152 is a RAID (Redundant Array of Independent Disks) storage array that combines multiple, physical disk drive components (e.g., a number of similar HDDs) into a single logical storage unit. In yet another embodiment, a SAN 152 is a virtual storage resource that provides a level of abstraction to the physical storage resources such that a virtual block address may be used to reference data stored in one or more corresponding blocks of memory on one or more physical non-volatile storage devices. In such an embodiment, the storage layer 122 may include a software framework, executed on one or more processors, for implementing the virtual storage resources.

The compute layer 124 includes the physical resources to execute processes (i.e., sets of instructions) in the cloud 100. The compute layer 124 may include a plurality of compute scale units (CSU) 154, each CSU 154 including at least one processor and a software framework for utilizing the at least one processor. In one embodiment, a CSU 154 includes one or more servers (e.g., blade servers) that provide physical hardware to execute sets of instructions. Each server may include one or more processors (e.g., CPU(s), GPU(s), ASIC(s), FPGA(s), DSP(s), etc.) as well as volatile memory for storing instructions and/or data to be processed by the one or more processors. The CSU 154 may also include an operating system, loaded into the volatile memory and executed by the one or more processors, that provides a runtime environment for various processes to be executed on the hardware resources of the server. In another embodiment, a CSU 154 is a virtual machine that provides a collection of virtual resources that emulate the hardware resources of a server. The compute layer 124 may include a hypervisor or virtual machine monitor that enables a number of virtual machines to be executed substantially concurrently on a single server.

The networking layer 126 includes the physical resources to implement networks. In one embodiment, the networking layer 126 includes a number of switches and/or routers that enable data to be communicated between the different resources in the cloud 100. For example, each server in the compute layer 124 may include a network interface controller (NIC) coupled to a network interface (e.g., Ethernet). The interface may be coupled to a network switch that enables data to be sent from that server to another server connected to the network switch. The networking layer 126 may implement a number of layers of the OSI model, including the Data Link layer (i.e., layer 2), the Networking layer (i.e., layer 3), and the Transport layer (i.e., layer 4). In one embodiment, the networking layer 126 implements a virtualization layer that enables virtual networks to be established within the physical network. In such embodiments, each NU 156 in the network layer 126 is a virtual private network (VPN).

It will be appreciated that each data center 110 in the plurality of data centers may include a different set of hardware resources and, therefore, a different number of resource pools 120. Furthermore, some resource pools 120 may exclude one or more of the storage layer 122, compute layer 124, and/or network layer 126. For example, one resource pool 120 may include only a set of servers within the compute layer 124. Another resource pool 120 may include both a compute layer 124 and network layer 126, but no storage layer 122.

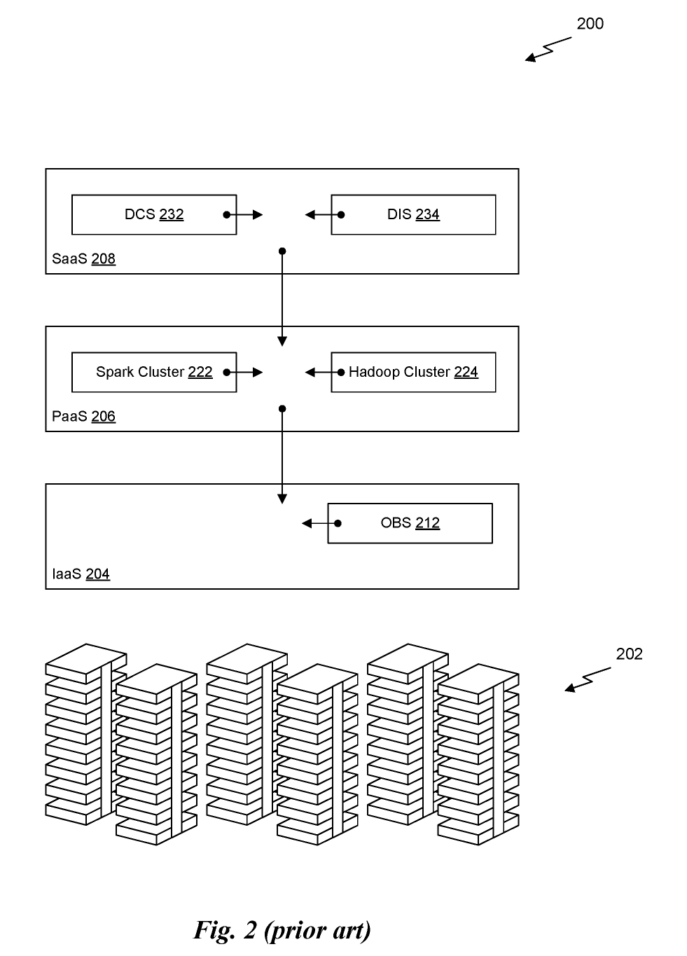

FIG. 2 is a conceptual illustration of a cloud architecture 200, in accordance with the prior art. As shown in FIG. 2, the cloud architecture 200 is represented as a plurality of hierarchical layers. The cloud architecture 200 includes a physical layer 202, an Infrastructure as a Service (IaaS) layer 204, a Platform as a Service (PaaS) layer 206, and a Software as a Service (SaaS) layer 208. The physical layer 202 is the collection of hardware resources that implement the cloud. In one embodiment, the physical layer 202 is implemented as shown in FIGS. 1A and 1B.

The IaaS layer 204 is a software framework that enables the resources of the physical layer 202 to be allocated to different infrastructure services. In one embodiment, the IaaS layer 204 includes a resource manager for allocating resource units (e.g., SAN 152, CSU 154, and NU 156) in the resource pools 120 of the physical layer 202 to services implemented within the IaaS layer 204. As shown in FIG. 2, services such as an Object Storage Service (OBS) 212 may be implemented in the IaaS layer 204. The OBS 212 is a cloud storage service for unstructured data that enables a client to store data in the storage layer 122 of one or more resource pools 120 in the physical layer 202. The OBS 212 may manage where data is stored (i.e., in what data center(s), on which physical drives, etc.) and how data is stored (i.e., n-way replicated data, etc.).

Each service in the IaaS layer 204 may include a separate resource manager that manages the resources allocated to the service. As shown in FIG. 2, black dots within a particular service denote a resource manager for that service and arrows represent a request for resources made by the resource manager of the service to a parent resource manager. In the case of the OBS 212, a resource manager within the OBS 212 requests resources from the resource manager of the IaaS layer 204. Again, the resource manager of the IaaS layer 204 manages the resources from the physical layer 202.

The OBS 212 is only one example of a service implemented within the IaaS layer 204, and the IaaS layer 204 may include other services in addition to or in lieu of the OBS 212. Furthermore, the IaaS layer 204 may include multiple instance of the same service, such as multiple instances of the OBS 212, each instance having a different client facing interface, such that different services may be provisioned for multiple tenants.

The next layer in the hierarchy is the PaaS layer 206. The PaaS layer 206 provides a framework for implementing one or more platform services. For example, as shown in FIG. 2, the PaaS layer 206 may include instances of a Spark Cluster service 222 and a Hadoop Cluster service 224. The Spark Cluster service 222 implements an instance of the Apache™ Spark® platform, which includes a software library for processing data on a distributed system. The Hadoop Cluster service 224 implements an instance of the Apache™ Hadoop® platform, which also includes a software library for processing data on a distributed system. Again, the Spark Cluster service 222 and the Hadoop Cluster service 224 are merely examples of platform services implemented within the PaaS layer 206, and the PaaS layer 206 may include other services in addition to or in lieu of the Spark Cluster service 222 and the Hadoop Cluster service 224.

The platform services in the PaaS layer 206, such as the Spark Cluster service 222 and the Hadoop Cluster service 224, each include an instance of a resource manager. The Spark Cluster service 222 and the Hadoop Cluster service 224 may both utilize the Apache YARN resource manager. These resource managers may request resources from a parent resource manager of the PaaS layer 206. The resource manager of the PaaS layer 206 manages the resources from the IaaS layer 204 allocated to the PaaS layer 206 by the resource manager in the IaaS layer 204.

The top layer in the hierarchy is the SaaS layer 208. The SaaS layer 208 may provide a framework for implementing one or more software services. For example, as shown in FIG. 2, the SaaS layer 208 may include instances of a Data Craft Service (DCS) service 232 and a Data Ingestion Service (DIS) service 234. The DCS service 232 implements an application for processing data, such as transferring or transforming data. The DIS service 234 implements an application for ingesting data, such as collecting data from a variety of different sources and in a variety of different formats and processing the data to be stored in one or more different formats. Again, the DCS service 232 and the DIS service 234 are merely examples of application services implemented within the SaaS layer 208, and the SaaS layer 208 may include other services in addition to or in lieu of the DCS service 232 and the DIS service 234.

The DCS service 232 and the DIS service 234 each include an instance of a resource manager. These resource managers may request resources from a parent resource manager of the SaaS layer 208. The resource manager of the SaaS layer 208 manages the resources allocated to the SaaS layer 208 by the resource manager of the PaaS layer 206.

It will be appreciated that each resource manager in the cloud architecture 200 is associated with a corresponding parent resource manager from which resource units are requested, which may be referred to herein as resource dependence. There may be exceptions to the arrows depicting resource dependence as shown in FIG. 2 when the resource dependence spans layers, such as if the Spark Cluster service 222 may request resources directly from the resource manager of the IaaS layer 204 rather than from the resource manager of the PaaS layer 206. However, in such resource dependence schemes, no single resource manager has visibility into each and every resource unit deployed in the cloud. Thus, no single resource manager can effectively manage the allocation of resource units between different services based on the utilization of each resource unit in the cloud.

It will be appreciated that the cloud architecture 200 shown in FIG. 2 is only one type of architecture framework implemented in conventional clouds. However, other cloud architectures may implement different frameworks. For example, a cloud architecture may include the IaaS layer 204 and the SaaS layer 208 without any intervening PaaS layer 206. In another example, a cloud architecture may include a Container as a Service (CaaS) layer (i.e., a new way of resource virtualization without IaaS and PaaS) plus an SaaS layer on top of the CaaS layer. In each instance, these cloud architectures employ a resource dependence scheme for requesting resources on which to run the service.

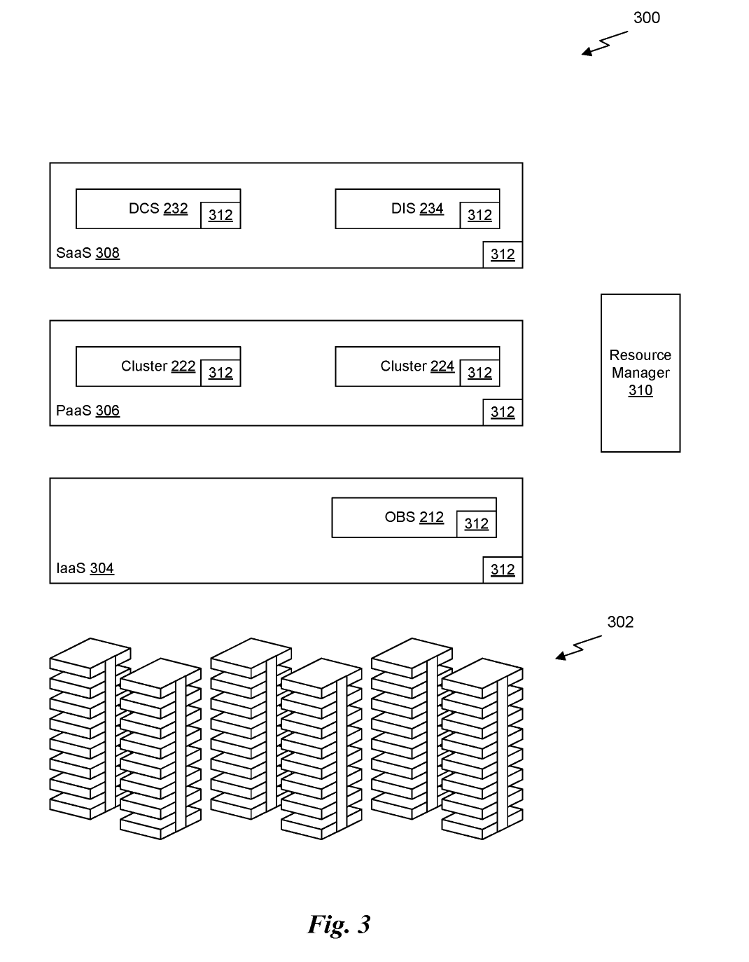

FIG. 3 is a conceptual illustration of a cloud architecture 300, in accordance with one embodiment. As shown in FIG. 3, the cloud architecture 300 is represented as a plurality of hierarchical layers, similar to the cloud architecture 200 shown in FIG. 2. The hierarchical layers may include a physical layer 302, an IaaS layer 304, a PaaS layer 306, and a SaaS layer 308. The IaaS layer 304 may include instances of various infrastructure services, such as the OBS 212; the PaaS layer 306 may include instances of various platform services, such as the Spark Cluster service 222 and the Hadoop Cluster service 224; and the SaaS layer 308 may include instances of various application services, such as the DCS service 232 and the DIS service 234. Again, the types or number of services implemented in each layer may vary according to a particular deployment of services in the cloud.

The cloud architecture 300 shown in FIG. 3 differs from the cloud architecture 200 shown in FIG. 2 in that the scheme utilized for resource allocation is not based on resource dependence. Instead, the cloud architecture 300 shown in FIG. 3 includes a unified resource manager 310 that allocates resource units to each layer or service deployed in the cloud. Each layer in the cloud includes a resource agent 312. In one embodiment, the resource agent 312 is a software module configured to manage the resources allocated to that resource agent 312. The resource agent 312 may request resource units from the resource manager 310 to be allocated to the resource agent 312. The resource manager 310 can allocate resource units independently to each layer of the cloud, and has visibility into the resource requirements of each layer of the cloud based on the requests received from each of the resource agents 312.

Each service may also include a resource agent 312. The resource agent 312 in each service requests resource units from the resource manager 310. Consequently, every resource agent 312 deployed in the cloud is dependent on the unified resource manager 310 such that the resource manager 310 can allocate resource units more efficiently within the cloud.

As used herein, a resource unit may refer to any logical unit of a resource. In the case of the physical layer 302, each resource unit may refer, e.g., to a SAN 152, a CSU 154, or a NU 156. These resource units can be allocated throughout the layers of the cloud. However, each layer and/or service may also define additional resource units that refer to virtual resources implemented by that layer or service. For example, the Spark Cluster service 222 may implement one or more Spark Clusters by grouping, logically, one or more resource units allocated to the Spark Cluster service 222 along with a framework for utilizing those resource units. Consequently, other services, such as services in the SaaS layer 308, may request the allocation of a Spark Cluster rather than the hardware resource units of the physical layer 302. In this case, a resource unit may refer to a Spark Cluster.

In one embodiment, the resource manager 310 may track the resources available in the cloud. The resource manager 310 may discover each of the resource units included in the physical layer 302 such as by polling each node in the cloud to report what resource units are included in the node. Alternatively, the resource manager 310 may read a configuration file, maintained by a network administrator that identifies the resource units included in the physical layer 302 of the cloud. In addition, each layer and/or service deployed within the cloud may stream resource information to the resource manager 310 that specifies any additional resource units implemented by those layers and/or services. The resource manager 310 is then tasked with allocating these resource units to other layers and/or services in the cloud.

In one embodiment, the resource manager 310 is executed on a node within the cloud architecture. More specifically, the resource manger 310 may be loaded on a server and executed by a processor on the server. The resource manager 310 may be coupled to other servers via network resources in the physical layer 302. Resource agents 312 executing on different servers may request resource units from the resource manger 310 by transmitting the request to the resource manager 310 via the network. In such an embodiment, a single instance of the resource manager 310 manages all of the resource units in the cloud.

In one embodiment, the resource manager 310 is a physically distributed, but logically centralized cloud plane. More specifically, a plurality of instances of the resource manager 310 may be loaded onto a plurality of different servers such that any resource agent 312 deployed in the cloud may request resource units from any instance of the resource manger 310 by transmitting the request to one instance of the resource manager 310 via the network. The multiple instances of the resource manager 310 may be configured to communicate such that resource allocation is planned globally be all instances of the resource manager 310. For example, one instance of the resource manager 310 may be loaded onto a single server in each data center 110 to provide high availability of the resource manager 310. In another example, one instance of the resource manager 310 may be loaded onto a single server in each availability zone of a plurality of availability zones. Each availability zone may comprise a number of data centers, such that all data centers in a particular geographic area are served by one instance of the resource manager 310.

The plurality of resource agents 312 may include a variety of resource agent types. Each resource agent 312 includes logic to implement a variety of functions specific to the type of layer or service associated with the resource agent 312. In one embodiment, a resource agent 312 is a stand-alone module designed with specific functionality for a particular layer or service. In another embodiment, a resource agent 312 is a container that wraps an existing resource manager of a service. For example, a service that was written for an existing cloud architecture may be modified to include a resource agent 312 that wraps the resource manager implemented in the service of the existing cloud architecture. The container may utilize the logic of the previous resource manager for certain tasks while making the resource manager compatible with the unified resource manager 310. In yet another embodiment, the resource agent 312 is a lightweight client, referred to herein as a resource agent fleet (RAF), such that only a basic amount of logic is included in the resource agent 312 and more complex logic is assumed to be implemented, if needed, by the resource manager 310. RAF resource agents 312 may be deployed in some SaaS services. A RAF resource agent 312 may be a simple software module that can be used for a variety of services and only provides the minimum level of functionality to make the service compatible with the unified resource manager 310.

The resource manager 310 collects information related to the resource units deployed in the cloud and develops a resource allocation plan allocating the resource units to the layers and/or services deployed in the cloud. However, as the number of services grows, the ability for simple logic implemented within the resource manager 310 to efficiently allocate resource units to the various services becomes more difficult. In such cases, logic to assist in determining how many resource units should be allocated to a particular service based on a specific request for resource units may be implemented external to the resource manager 310 and utilized by the resource manager 310 when developing or adjusting the resource allocation plan.

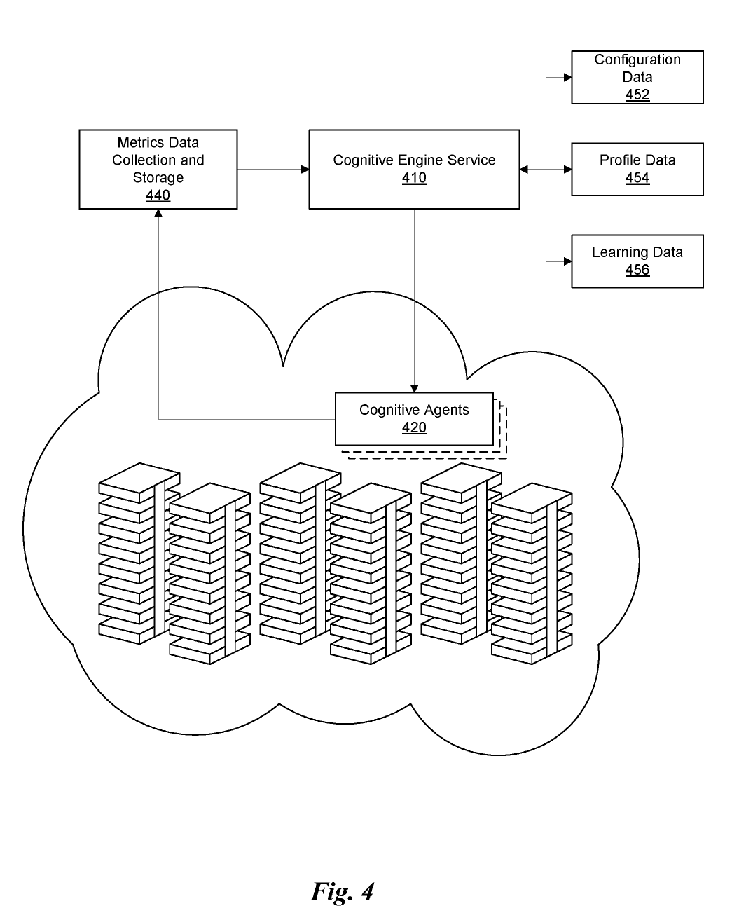

FIG. 4 illustrates a cognitive engine service 410, in accordance with one embodiment. The cognitive engine service 410 is a software module that is configured to implement machine-learning to assist in determining how many resource units should be allocated to a particular service based on a specific request for resource units. As shown in FIG. 4, the cognitive engine service 410 is coupled to a plurality of cognitive agents 420 deployed in the cloud. The cognitive agents 420 are configured to collect metrics data for tasks executed in the cloud and to transmit the metrics data to a metrics data collection and storage module 440 associated with the cognitive engine service 410. The metrics data may be analyzed by the cognitive engine service 410 in order to adjust the global resource allocation plan.

In one embodiment, each node in a plurality of nodes in the cloud includes a cognitive agent 420 stored in a memory and executed by one or more processors of the node. As used herein, a node may refer to a server or a virtual machine executed by a server. Each instance of a cognitive agent 420 included in a node collects metrics data for that node. The metrics data includes, but is not limited to, a processor utilization metric, a memory utilization metric, and/or a network bandwidth utilization metric. The cognitive agent 420 is configured to track tasks being executed by the node and sample values for each metric during execution of the task. In one embodiment, the cognitive agent 420 is configured to sample values for each of the metrics at a fixed sampling frequency (e.g., every 100 ms, every second, every minute, etc.) and transmit a record containing the sampled values for each metric to the metrics data collection and storage module 440 each time a task completes execution. In another embodiment, the cognitive agent 420 is configured to sample values for each of the metrics over the duration of the task and calculate an average value for the metric at the completion of the task. The average values for the one or more metrics is transmitted to the metrics data collection and storage module 440. In yet another embodiment, the cognitive agent 420 is configured to track metric values during the duration of the task and calculate statistical measurements corresponding to the metric at the completion of the task. For example, the cognitive agent 420 may calculate a minimum and maximum value for a metric during the duration of the task, or the cognitive agent 420 may calculate a mean value for the metric and a variance of the metric during the duration of the task. The statistical measurements may be sent to the metrics data collection and storage module 440 rather than the actual sampled values of the metrics.

In one embodiment, the cognitive engine service 410 trains one or more models based on the metrics data. Each model in the one or more models implements a machine learning algorithm. Machine learning algorithms include, but are not limited to, e.g., classification algorithms, regression algorithms, or clustering algorithms. Classification algorithms include, e.g., a decision tree algorithm, a support vector machine (SVM) algorithm, a neural network, and a random forest algorithm, and the like. Regression algorithms include, e.g., a linear regression algorithm, ordinary least squares regression algorithms, and the like. Clustering algorithms include, e.g., a K-means algorithm, a hierarchical clustering algorithm, and a highly connected subgraphs (HCS) algorithm, and the like. Each machine learning algorithm may be associated with a number of parameters that can be set to configure the model, which may be stored in a memory as configuration data 452. For example, a neural network can be associated with a set of weights, each weight utilized in a calculation implemented by a neuron of the neural network. The set of weights associated with the neural network may be stored as the configuration data 452 for the model that implements the neural network.

As tasks are executed in the cloud, the cognitive engine service 410 generates a profile associated with each task. In one embodiment, the profile includes a customer identifier, a task identifier, and a size of a data set processed by the task on one or more nodes of the cloud. The customer identifier represents a particular customer corresponding to the task being initiated. The task identifier is a unique value assigned to the task that differentiates a particular task from one or more other tasks executed in the cloud. The size of the data set is a size, in bytes, of the data set to be processed by the task. In another embodiment, the profile may contain other information in addition to, or in lieu of, the customer identifier, the task identifier, and the size of a dataset. For example, the profile may only include a customer identifier and a task classification, which identifies the type of task rather than the discrete tasks. A task identifier may be generated to track the metrics data from multiple cognitive agents 420 as applying to a particular task, but the task identifier may not be included in the profile. In another example, the profile may contain a customer identifier, a task identifier, a dataset identifier, and a timestamp that indicates when the task was initiated. In general, the profile is utilized by the cognitive engine service 410 to identify information associated with the task. It will be appreciated that the profile may include information that identifies a particular customer because any particular customer is likely to initiate lots of similar tasks, such that a profile that correlates a customer with a task is useful to predict future tasks initiated by the customer. The cognitive engine service 410 may store profile data 454 for a plurality of tasks in a memory accessible by the cognitive engine service 410.

As each task is executed in the cloud, the cognitive agents 420 collect metrics data corresponding to the task. The metrics data is transmitted to the metrics data collection and storage module 440 along with a task identifier for the task. The metrics data collection and storage module 440 may process the metrics data received from a plurality of cognitive agents 420 in order to aggregate metrics data from multiple nodes associated with the same task. In one embodiment, the metrics data collection and storage module 440 may poll each cognitive agent 420 in a round robin fashion to request any new metrics data collected since the last time the cognitive agent 420 was polled. In another embodiment, the cognitive agents 420 may asynchronously transmit collected metrics data to the metrics data collection and storage module 440 when each task, or portion of a task, finishes execution on a node corresponding to the cognitive agent 420. The metrics data collection and storage module 440 may include a buffer, such as a FIFO (First-in, First-out) implemented in a memory, that stores records of metrics data received from the plurality of cognitive agents 420 temporarily until the metrics data can be processed by the metrics data collection and storage module 440.

The metrics data collection and storage module 440 may accumulate metrics data from multiple cognitive agents 420 corresponding to a single task into a collection of metrics data for the task. Once the metrics data collection and storage module 440 has received metrics data from all of the cognitive agents 420 associated with a particular task (i.e., after the task has completed execution), the metrics data collection and storage module 440 may process the plurality of metrics data from different cognitive agents into a collection of metrics data for the task. The collection of metrics data may be generated by combining metrics data from individual cognitive agents 420; e.g., by calculating a mean of values for each metric from the plurality of cognitive agents 420. In another embodiment, the metrics data collection and storage module 440 may simply collect the metrics data from the plurality of cognitive agents 420 into a data structure, such as a 2D array that stores multiple values for each of a plurality of metrics and store the data structure in the memory.

The metrics data collection and storage module 440 is configured to transmit the collection of metrics data for the task to the cognitive engine service 410. In one embodiment, the cognitive engine service 410 is configured to calculate a score corresponding to each task in one or more tasks based on the metrics data, and correlate the scores calculated for the one or more tasks to corresponding profiles for the one or more tasks. The score may represent a value that measures the efficiency of performing the task with a particular number of resource units. For example, the score can be calculated based on an elapsed time taken to complete the task, an average CPU utilization rate during the execution of the task, and so forth. It will be appreciated that any formula may be selected for calculating the scores associated with the tasks, and that the score provides a metric for comparing the execution of different tasks using different numbers of resource units. The information correlating scores and profiles may be stored in a memory as learning data 456. In one embodiment, correlating the scores and profiles comprises adding the score to the profile.

After a number of tasks have been executed, one or more models can be trained to select an optimal number of resource units to allocate to a particular task. In one embodiment, a separate and discrete model may be generated for each unique customer identifier included in the profile data 454. In another embodiment, profiles may be grouped together based on similarity and a model may be generated for each set of similar profiles. In yet another embodiment, one model may be generated for the entire set of profiles.

Again, each model implements a machine learning algorithm, such as a regression algorithm. The learning data 456 collected during execution of tasks in the cloud may be utilized to train the model. Training refers to adjusting the parameters of the model based on analysis of the learning data. For example, the learning data 456 may be implemented as a database of profiles, where each profile includes information related to one or multiple tasks initiated by one or multiple customers, a size of a dataset for each task, a number of resource units allocated to each task, and a score generated by the cognitive engine service 410 based on the metrics data collected while executing the task. The database may be queried to return data entries associated with a subset of profiles, which may be used as training data to generate a model for these profiles. Consequently, the parameters may be adjusted by comparing the output of the model and the results of previous tasks executed in the cloud, as stored in the returned set of profiles. For example, each profile for the particular customer and task includes a number of resource units allocated to the task and a score corresponding to the metrics data collected when executing the task. The parameters of the model may be adjusted so that the model predicts the most likely score when a task for processing a dataset is assigned a number of resource units to execute that task given a size of the dataset. By running the model for a given dataset and varying numbers of resource units, a plurality of predicted scores may be correlated with different numbers of resource units and analyzed to select an optimal number of resource units based on the predicted scores. As used herein, the term optimal refers to any preferred number of resource units over other numbers of resource units, based on any of a variety of criteria as determined by the particular application.

When a task is first executed, a profile is created and the customer identifier and the task identifier are used to identify the profile. Each time the task is executed, the size of the data and the number of resource units N allocated to the task are stored in the profile. Each execution of the task is assigned a score by the cognitive engine service 410, which is stored in the learning data 456 and correlated with the profile. When a threshold number of scores correlated to the profile have been collected in the learning data 456, then a model is trained using the scores in the learning data 456. The profile identified by the <customer_id, task_id> tuple is associated with the trained model. In particular, the <size, N, score> tuples in the learning data 456 are utilized to train the model, which takes the size of the dataset and the number of resource units N as input to the model and predicts the score. A threshold value is provided to the cognitive engine service 410 to specify the desired score to achieve and help the cognitive engine service 410 select an optimal number of resource units N based on this threshold value.

Once the one or more model(s) are trained based on the learning data 456, the resource manager 310 may utilize the cognitive engine service 410 when developing the global resource allocation plan. As new tasks are initiated by a service, the service may request resources from the resource manager 310. The resource manager 310 may transmit a request to the cognitive engine service 410 in order to generate an optimal number of resource units to allocate to the task. The request may include a task identifier and a size of the dataset to be operated on by the task. The cognitive engine service 410 may transmit a list of values for N back to the resource manager 310, which will attempt to allocate an optimal number of resource units corresponding to one of the values of N, from the list, to the service or layer that requested resource units, if said resource units are available. In one embodiment, the values of N are transmitted in the list along with corresponding predicted scores generated by the model. The resource manager 310 may select an optimal value of N from the list based on various criteria. For example, the resource manager 310 may select values of N based on available numbers of resource units. As another example, the resource manager 310 may select values of N based on the predicted scores, such as by determining the largest score, or by determining the most optimal ratio of score to numbers of resource units.

As new tasks are executed, additional metrics data for the tasks are collected by the cognitive agents 420 and utilized to store scores and other metrics data in the learning data 456. The scores and other metrics data may be correlated to an already existing profile in profile data 454, or a new profile may be created and added to profile data 454 and then the scores and other metrics data may be correlated to the new profile. In addition, these new samples, including the size of the dataset to be processed by the task, the number of resource units N allocated to the task, and a score calculated for the task based on the collected metrics data, may be used to further train the model(s). Thus, the models are dynamically adjusted to track the most efficient use of resource units in the cloud. In other words, the algorithm for selecting the number of resource units to allocate to a task is continuously monitoring the most efficient use of resources and adjusting the allocation of resources when results change.

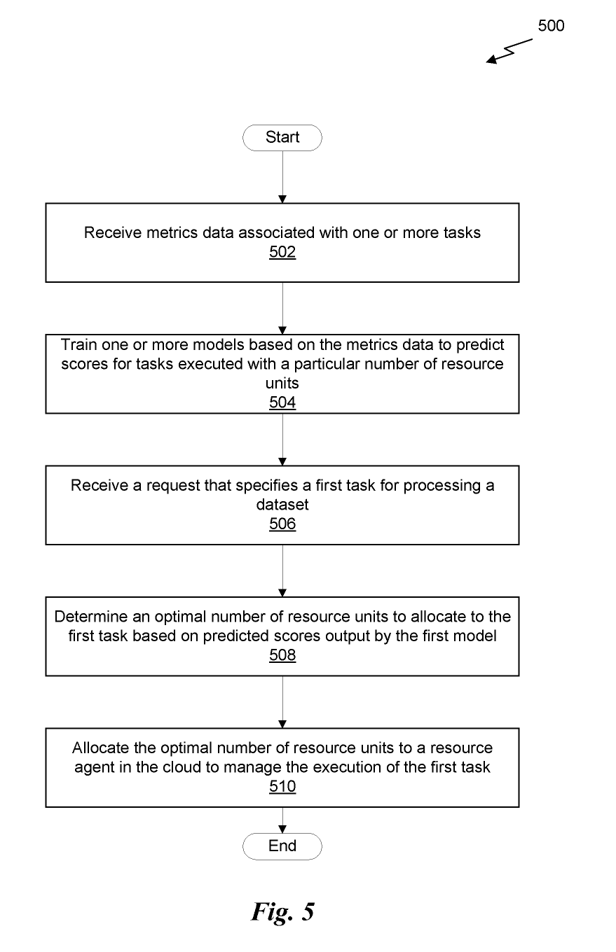

FIGS. 5 is a flowchart of a method 500 for determining a number of resource units to allocate to a task, in accordance with one embodiment. The method 500 may be performed by hardware, software, or a combination of hardware and software. In one embodiment, the method 500 is implemented by the cognitive engine service 410 executed on one or more nodes of the cloud.

At step 502, metrics data associated with one or more tasks is received. In one embodiment, the cognitive engine service 410 receives metrics data from a plurality of cognitive agents 420. The metrics data may be received directly from the plurality of cognitive agents 420, or indirectly via an intervening metrics data collection and storage module 440 that collects metrics data from the plurality of cognitive agents 420 and aggregates the metrics data for each task in a collection of metrics data that is forwarded to the cognitive engine service 410.

At step 504, one or more models are trained based on the metrics data to predict scores for tasks executed with a particular number of resource units. In one embodiment, metrics data may be received for a plurality of completed tasks and stored as learning data 456. The cognitive engine service 410 may calculate a score for each completed task based on the corresponding metrics data. The score, metrics data, and size of the associated task may be stored as a sample in the learning data 456. A plurality of samples from the learning data 456 may be utilized to train the model(s). In one embodiment, the cognitive engine service 410 is configured to update a model each time metrics data associated with a task is received by the cognitive engine service 410.

At step 506, a request that specifies a first task for processing a dataset is received. In one embodiment, a resource manager 310 is notified each time a task is initiated by a service deployed in the cloud. Notification may be embodied in a request for resource units to be allocated to a service to execute the task. The resource manager 310 may send a request to the cognitive engine service 410 that includes a customer identifier, a task identifier, and a size of the dataset to be processed by the task.

At step 508, an optimal number of resource units to allocate to the first task is determined based on predicted scores output by the first model. In one embodiment, the cognitive engine service 410 selects a profile corresponding to the task using the customer identifier and task identifier included in the request. If a profile exists for that customer and task, then that profile is read from the profile data 454 and utilized to select a particular model from one or more models corresponding to the profiles. If a profile does not exist, then a similar profile may be selected and utilized to select a particular model. The size of the dataset and a number of resource units may then be provided as input to the model, which is designed to generate a predicted score if the number of resource units were allocated to execute the first task. The model may be run multiple times to generate a number of predicted scores for different numbers of resource units. The model implements a machine learning algorithm, such as a regression algorithm. The output(s) of the model may be transmitted from the cognitive engine service 410 to the resource manager 310 in order for the resource manager 310 to determine the optimal number of resource units to allocate to the first task. The resource manager 310 tracks information related to the resource units available in the cloud and, therefore, can select an optimal number of resource units to allocate to the first task based on the predicted scores output by the model.

At step 510, the resource manager 310 allocates the optimal number of resource units to a service in the cloud to manage the execution of the first task. In one embodiment, the resource manager 310 adjusts a global resource allocation plan that specifies which resource units are allocated to each resource agent 312 in the cloud 300. The optimal number of resource agents may be allocated to a resource agent 312 assigned to manage execution of the task in the global resource allocation plan.

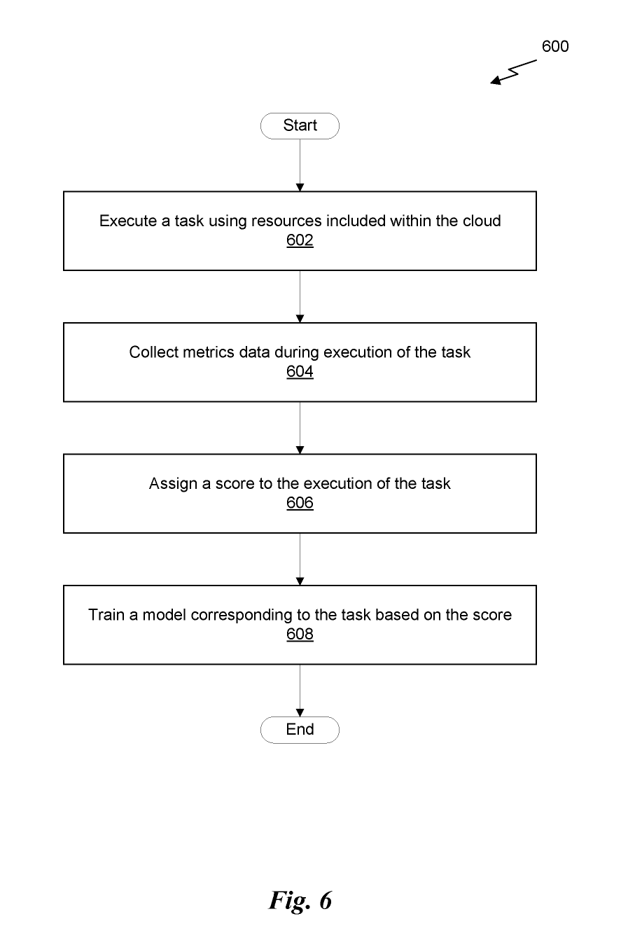

FIG. 6 is a flowchart of a method 600 for training a model, in accordance with one embodiment. The method 600 may be performed by hardware, software, or a combination of hardware and software. In one embodiment, the method 600 is implemented by the cognitive engine service 410 executed on one or more nodes of the cloud.

At step 602, a task is executed utilizing resources included within a cloud. In one embodiment, a resource manager 310 allocates a number of resource units to a resource agent 312 for a service. The service utilizes the resource units allocated to the service to execute the task on one or more nodes in the cloud. At step 604, metrics data is collected during execution of the task. In one embodiment, one or more cognitive agents collect metrics data on the nodes executing the task and transmit the metrics data to the cognitive engine service 410, either directly or indirectly via a metrics data collection and storage module 440. The metrics data may include the metrics data includes at least one of a processor utilization metric, a memory utilization metric, a network bandwidth utilization metric, and an amount of time elapsed to execute the task.

In one embodiment, the amount of time elapsed to execute the task is measured by a cognitive agent 420 and included in the metrics data submitted to the metrics data collection and storage module 440. In another embodiment, the cognitive engine service 410 receives a timestamp from the resource manager 310 that indicates the start of the task, and metrics data from each cognitive agent 420 includes a timestamp that indicates a time that at least a portion of the task was finished on the corresponding node. The cognitive engine service 410 then calculates a difference between the maximum timestamp received from each of a plurality of cognitive agents 420 assigned at least a portion of the task and the timestamp received from the resource manager 310 that indicates the start of the task as the amount of time elapsed to execute the task.

At step 606, a score is assigned to the execution of the task. In one embodiment, the cognitive engine service 410 calculates a score for the execution of the task based on the metrics data collected during execution of the task. The score, metrics data, and a size of the dataset may be stored in the learning data 456 as a sample. The sample may be correlated to a profile associated with the task in the profile data 454. At step 608, a model corresponding to the task is trained based on score. In one embodiment, the cognitive engine service 410 updates the parameters for the model based on the score calculated for the execution of the task and the number of resource units N allocated to the task.

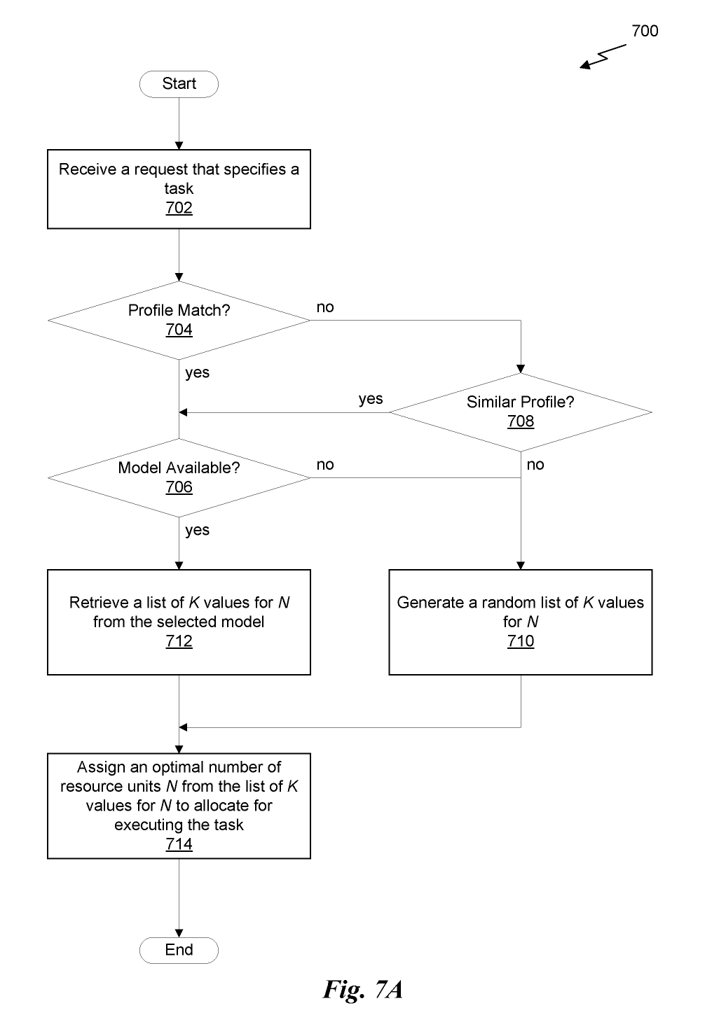

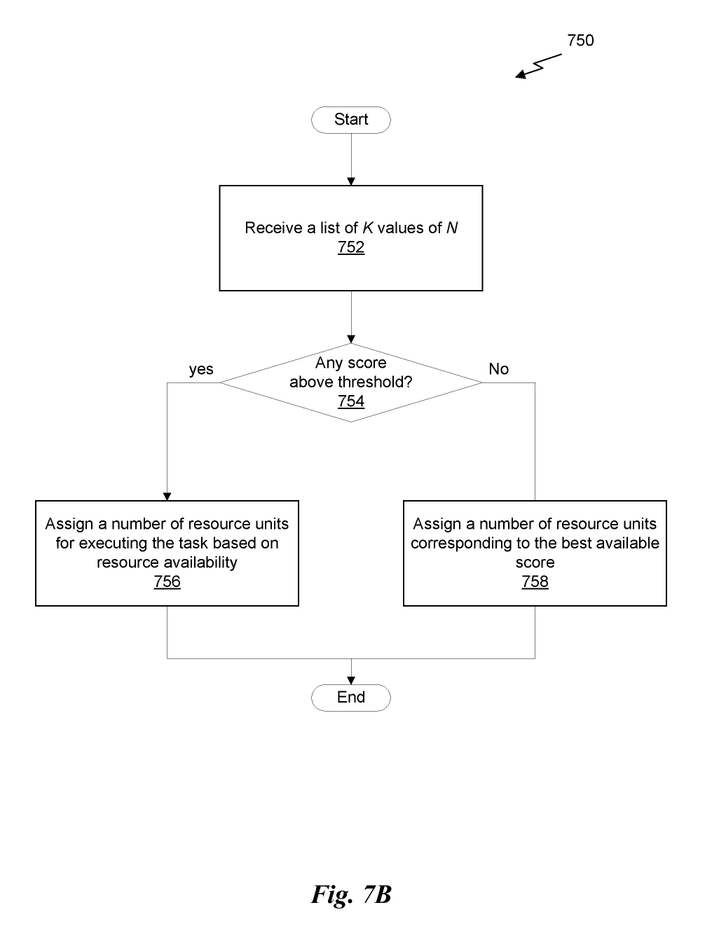

FIGS. 7A is a flowchart of a method 700 for determining an optimal number of resource units to allocate to a task, in accordance with another embodiment. The method 700 may be performed by hardware, software, or a combination of hardware and software. In one embodiment, the method 700 is implemented by the cognitive engine service 410 and/or the resource manager 310 executed on one or more nodes of the cloud.

At step 702, a request that specifies a task is received. In one embodiment, a resource manager 310 transmits a request to the cognitive engine service 410, the request including a customer identifier, a task identifier, and a size of the dataset to be processed by the task. In another embodiment, the request includes a customer identifier, task identifier, and other configuration data for the task (e.g., a size of the dataset to be processed by the task, parameters for configuring the task, an allotted time to complete the task, etc.).

At step 704, the cognitive engine service 410 determines if a matching profile exists. In one embodiment, the cognitive engine service 410 uses the customer identifier and task identifier to search for a matching profile in the profile data 454. If a matching profile is found, then, at step 706, the cognitive engine service 410 determines whether a model is available corresponding to the profile. Each profile in the profile data 454 may be associated with a corresponding model. For example, profiles for a plurality of customers may be associated with a particular model, each profile for a customer in the plurality of customers being linked with the model. If a model is associated with the profile, then, the method 700 proceeds to step 712, discussed in more detail below. However, if a model is not associated with the selected profile, then the method 700 proceeds to step 710, discussed in more detail below.

Returning to step 704, if no matching profile exists in the profile data 454, then, at step 708, the cognitive engine service 410 determines if a similar profile exists in the profile data 454. A similar profile may be a profile with selection characteristics closest to the customer identifier and task identifier included in the request. For example, a profile with a selection characteristic that matches the customer identifier but does not match the task identifier included in the request may be selected as a similar profile. Alternately, a profile with a selection characteristic having a different customer identifier but the same task identifier included in the request may be selected as the similar profile. In one embodiment, customers and or tasks may be analyzed to determine similarity based on a variety of measures and sets of customer identifiers and/or task identifiers may be correlated as “similar”. For example, the field of business of a customer, a number of employees of the customer, and/or gross annual revenue of a customer may be analyzed and customers within the same general field of business, having relatively similar numbers of employees and/or gross revenue may be deemed to be “similar” for purposes of selecting a similar profile. Similarity between customers is useful because similar customers are likely to run similar tasks, with similar sized datasets. Thus, an efficient use of resources for one customer is likely to be efficient for another similar customer as well. Therefore, a model trained using learning data 456 associated with one customer may apply to a separate, similar customer.

If a similar profile is included in the profile data 454, then the method 700 returns to step 706, where the cognitive engine service 410 determines whether a model is available corresponding to the similar profile. Returning to step 708, if a similar profile is not included in the profile data 454, then, at step 710, the cognitive engine service 410 generates a random list of K values for N (i.e., the number of resource units to allocate for executing the task). In one embodiment, K is equal to one such that a single random value for N is generated that represents the number of resource units to allocate to execute the task. In another embodiment, K is greater than one such that one of multiple values for N can be selected by the resource manager 310 based on some other consideration, such as resource availability.

It will be appreciated that without a profile match at step 704, or even the existence of a similar profile at step 706, then there may be no model provided that has been trained with learning data 456 linked to the task. Consequently, the number of resource units to allocate to a task is randomly generated, and the results of the execution will provide a sample to correlate with a new profile in order to link the profile to a trained model at some point in the future when enough samples have been collected. In one embodiment, a new profile corresponding to the customer identifier and the task identifier included in the request may be added to the profile data 454 and a new model may be created and after the task has been executed so that similar tasks will be associated with a profile having a corresponding model in the system.

Returning to step 712, a list of K values for N is retrieved from the selected model. Again, the selected model may correspond to a profile that matches the task (i.e., customer identifier, task identifier tuple) included in the request, or a profile that is similar to the task included in the request. In one embodiment, the list of K values of N includes a single value of N that indicates an optimal number of resource units to allocate to execute the task according to the output(s) of the model. In another embodiment, the list of K values of N includes multiple values of N, each value of N corresponding to a predicted score, as output by the model.

At step 714, the resource manager 310 assigns an optimal number of resource units N from the list of K values for N to allocate for executing the task. In one embodiment, the resource manager 310 selects the optimal number of resource units by randomly selecting one value of N from the list of K values for N. For example, if the list of K values for N includes 3 values for N, then the resource manager 310 selects one of the three values for N at random. In another embodiment, the resource manager 310 may consider other factors, such as resource availability when choosing the optimal number of resource units N from the K values for N.

FIG. 7B is a flowchart of a method 750 for assigning an optimal number of resource units to allocate, in accordance with one embodiment. The method 750 may be performed by hardware, software, or a combination of hardware and software. In one embodiment, the method 750 is implemented by the resource manager 310 executed on one or more nodes of the cloud, and may comprise a detailed implementation of step 714 of method 700.

At step 752, a list of K values for N is received. In one embodiment, the list of K values for N includes K scalar values for N, where each scalar value indicates a number of resource units N to allocate for executing a task. In another embodiment, the list of K values for N may specify K vectors for N, where each vector includes two or more scalar values for N resource units of each type of a plurality of different types of resource units (e.g., compute units, storage units, etc.).

At step 754, the resource manager 310 determines whether any predicted score associated with the K values for N is above a threshold value. In one embodiment, each value of N in the list of K values for N represents an input to a model to generate a predicted score for that value of N. A threshold value for a satisfactory score may be set that indicates whether a predicted score corresponds with a satisfactory result. If any predicted score associated with one of the K values for N is above the threshold value, then, at step 756, the resource manager 310 assigns an optimal number of resource units for executing the task based on resource availability. In one embodiment, the resource manager 310 selects a subset of values in the list of K values for N that have scores (or average scores) above the threshold value as potential numbers of resource units to allocate for executing the task. Then, the resource manager 310 selects one value from the subset of values as the number of resource units to assign based on whether that number of resource units is available. The cognitive engine service 410 may start with the highest predicted score when determining availability, and work down through the subset of values by decreasing score until a particular number of resource units that is available is found. If no value in the subset of values is associated with available resource units, then the smallest value in the subset of values may be selected.

Returning to step 754, if none of the predicted scores associated with one of the K values for N is above the threshold value, then the resource manager 310 assigns a number of resource units corresponding to the best available predicted score. In one embodiment, when all predicted scores fall below the threshold value, then the number of resource units associated with the best predicted score will be selected to provide the most satisfactory result, without regard to availability of the resources. In other words, resource availability will only be considered when there are multiple different allocations of resource units that may provide a satisfactory result. Otherwise, allocation of resource units will attempt to provide for the result that is most satisfactory, even when resource contention is an issue.

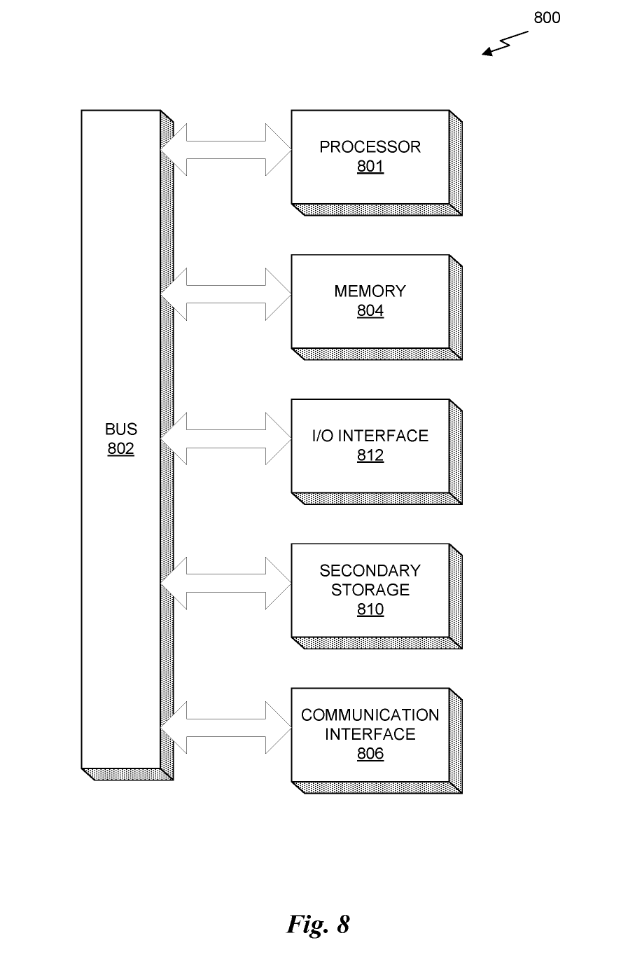

FIG. 8 illustrates an exemplary system 800 in which the various architecture and/or functionality of the various previous embodiments may be implemented. As shown, a system 800 is provided including at least one processor 801 that is connected to a communication bus 802. The communication bus 802 may be implemented using any suitable protocol, such as PCI (Peripheral Component Interconnect), PCI-Express, AGP (Accelerated Graphics Port), HyperTransport, or any other bus or point-to-point communication protocol(s). The system 800 also includes a memory 804. Control logic (software) and data are stored in the memory 804 which may take the form of random access memory (RAM).

The system 800 also includes an input/output (I/O) interface 812 and a communication interface 806. User input may be received from the input devices 812, e.g., keyboard, mouse, touchpad, microphone, and the like. In one embodiment, the communication interface 806 may be coupled to a graphics processor (not shown) that includes a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 800 may also include a secondary storage 810. The secondary storage 810 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the memory 804 and/or the secondary storage 810. Such computer programs, when executed, enable the system 800 to perform various functions. The memory 804, the storage 810, and/or any other storage are possible examples of computer-readable media.

In one embodiment, the architecture and/or functionality of the various previous figures may be implemented in the context of the processor 801, a graphics processor coupled to communication interface 806, an integrated circuit (not shown) that is capable of at least a portion of the capabilities of both the processor 801 and a graphics processor, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 800 may take the form of a desktop computer, laptop computer, server, workstation, game consoles, embedded system, and/or any other type of logic. Still yet, the system 800 may take the form of various other devices including, but not limited to a personal digital assistant (PDA) device, a mobile phone device, a television, etc.

Further, while not shown, the system 800 may be coupled to a network (e.g., a telecommunications network, local area network (LAN), wireless network, wide area network (WAN) such as the Internet, peer-to-peer network, cable network, or the like) for communication purposes.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVDTM), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the embodiments as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer-implemented method for allocating resources within a cloud, comprising:
receiving, at a cognitive engine service in communication with a plurality of cognitive agents deployed in the cloud, metrics data associated with one or more tasks, wherein the metrics data is collected by the plurality of cognitive agents;
training one or more models based on the metrics data to predict scores for tasks executed with a particular number of resource units;
receiving a request that specifies a first task for processing a dataset;
determining an optimal number of resource units to allocate to the first task based on predicted scores output by a first model; and
allocating the optimal number of resource units to a resource agent in the cloud to manage the execution of the first task.

2. The method of claim 1, wherein each model in the one or more models implements a machine learning algorithm.

3. The method of claim 2, wherein the machine learning algorithm is a regression algorithm.

4. The method of claim 1, wherein the profile comprises a customer identifier and a task identifier, and wherein the profile is utilized to select the first model from the one or more models.

5. The method of claim 1, wherein the metrics data includes at least one of a processor utilization metric, a memory utilization metric, a network bandwidth utilization metric, and an amount of time elapsed to execute the task, and wherein the cognitive engine service is configured to calculate a score corresponding to each task in the one or more tasks based on the metrics data.

6. The method of claim 5, further comprising correlating scores calculated for the one or more tasks to corresponding profiles.

7. The method of claim 1, wherein the cloud comprises a plurality of nodes in one or more data centers, each node in the plurality of nodes in communication with at least one other node in the plurality of nodes through one or more networks.

8. The method of claim 7, wherein each node in the plurality of nodes includes a cognitive agent stored in a memory and executed by one or more processors of the node.

9. A system for allocating resources within a cloud, comprising:
a non-transitory memory storage comprising instructions; and
one or more processors in communication with the memory, wherein the one or more processors execute the instructions to:
receive, at a cognitive engine service in communication with a plurality of cognitive agents deployed in the cloud, metrics data associated with one or more tasks, wherein the metrics data is collected by the plurality of cognitive agents,
train one or more models based on the metrics data to predict scores for tasks executed with a particular number of resource units,
receive a request that specifies a first task for processing a dataset,
determine an optimal number of resource units to allocate to the first task based on predicted scores output by a first model, and
allocate the optimal number of resource units to a resource agent in the cloud to manage the execution of the first task.

10. The system of claim 9, wherein each model implements a machine learning algorithm.

11. The system of claim 10, wherein the machine learning algorithm is a regression algorithm.

12. The system of claim 9, wherein the profile comprises a customer identifier and a task identifier, and wherein the profile is utilized to select the first model from the one or more models.

13. The system of claim 9, wherein the metrics data includes at least one of a processor utilization metric, a memory utilization metric, a network bandwidth utilization metric, and an amount of time elapsed to execute the task, and wherein the cognitive engine service is configured to calculate a score corresponding to each task in the one or more tasks based on the metrics data.

14. The system of claim 13, the cognitive engine service further configured to correlate scores calculated for the one or more tasks to corresponding profiles.

15. The system of claim 9, wherein the cloud comprises a plurality of nodes in one or more data centers, each node in the plurality of nodes in communication with at least one other node in the plurality of nodes through one or more networks.

16. The system of claim 15, wherein each node in the plurality of nodes includes a cognitive agent stored in a memory and executed by one or more processors of the node.

17. A non-transitory computer-readable media storing computer instructions for reducing power consumption of a mobile device that, when executed by one or more processors, cause the one or more processors to perform the steps of:
receiving, at a cognitive engine service in communication with a plurality of cognitive agents deployed in the cloud, metrics data associated with one or more tasks, wherein the metrics data is collected by the plurality of cognitive agents;
training one or more models based on the metrics data to predict scores for tasks executed with a particular number of resource units;
receiving a request that specifies a first task for processing a dataset;
determining an optimal number of resource units to allocate to the first task based on predicted scores output by a first model; and
allocating the optimal number of resource units to a resource agent in the cloud to manage the execution of the first task.

18. The non-transitory computer-readable media of claim 17, wherein each model implements a machine learning algorithm.

19. The non-transitory computer-readable media of claim 17, wherein the profile comprises a customer identifier and a task identifier, and wherein the profile is utilized to select the first model from the one or more models.

20. The non-transitory computer-readable media of claim 17, wherein the metrics data includes at least one of a processor utilization metric, a memory utilization metric, a network bandwidth utilization metric, and an amount of time elapsed to execute the task, and wherein the cognitive engine service is configured to calculate a score corresponding to each task in the one or more tasks based on the metrics data.
